(19) United States
(12) Patent Application Publication
(10) Pub. No.: US 2015/0158264 A1
(43) Pub. Date: Jun. 11, 2015

(54) INTERACTIVE PROCESS CONTROL FOR SINGLE FACE PRODUCTION

(71) Applicant: Marquip, LLC, Phillips, WI (US)

(72) Inventor: John Robert Sofinowski, Jarrettsville, MD (US)

(73) Assignee: Marquip, LLC, Phillips, WI (US)

(21) Appl. No.: 14/540,787

(22) Filed: Nov. 13, 2014

Related U.S. Application Data
(60) Provisional application No. 61/912,131, filed on Dec. 5, 2013.

(51) Int. Cl. B31F 1/28; B31F 1/20

(52) U.S. Cl. CPC B31F 1/2831; B31F 1/20; B31F 1/285; B31F 1/2804

(57) ABSTRACT

A method for minimizing cross-machine direction variations in temperature and moisture content of a web running through a corrugator single facer. The method includes running the web through a web preheater station of the single facer and capturing an image representing an actual temperature of the web downstream of the preheater station in the cross-machine direction with a thermal imaging device. The method includes sending the image to a programmed process controller that applies thermal pattern recognition to the image and determining with the controller if the actual temperature of the web deviates from a desired temperature range. The method also includes determining with the controller a corrective action that will bring the actual temperature of the web within the desired temperature range and generating and sending a control signal with the controller to vary an operating condition of the preheater station so as to bring about the corrective action.

### CROSS-REFERENCE TO RELATED APPLICATION

The present application is based on and claims priority to U.S. Provisional Patent Application Ser. No. 61/912,131 filed Dec. 5, 2013, the disclosure of which is incorporated herein by reference.

### BACKGROUND OF THE INVENTION

U.S. Pat. No. 6,050,316, which is hereby incorporated by reference, discloses a single facer including a preheater for conditioning a paperboard web. The preheater is positioned upstream form a corrugating nip and includes an arcuate surface facing the web. A plurality of primary channels are disposed internally within the preheater in thermal communication with the arcuate surface. High pressure steam is supplied to the primary channels for heating the arcuate surface. A plurality of outlet ports extend within the preheater and are in fluid communication with the heated arcuate surface. Low pressure steam is released through the plurality of outlet ports thereby producing a steam film between the heated arcuate surface and the paperboard web. The steam film dramatically increases heat transfer to the paperboard web while also reducing frictional forces opposing movement of the web.

U.S. Pat. No. 6,110,095, which is hereby incorporated by reference, discloses an apparatus and related method for forming a double face paperboard web. The apparatus of the present invention includes a heating section upstream from a drawing section. The heating section includes at least one heating plate having an upper surface facing a paperboard web and heated by a plurality of primary channels supplied with steam. A plurality of secondary channels extend through the heating plate intermediate the primary channels and a lower surface of the plate. A plurality of outlet ports communicate with each secondary channel and the upper surface of the heating plate. Steam supplied to the secondary channels exits through the outlet ports thereby producing a steam film between the upper surface of the heating plate and the lower surface of the paperboard web. The steam film substantially reduces frictional forces opposing movement of the web while also dramatically increasing the heat transfer to the paperboard web and accelerating the gelatinization of the glue therein.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

The present disclosure is of a method for minimizing cross-machine direction variations in temperature and moisture content of a web running through a corrugator single facer. The method includes running the web through a web preheater station of the single facer and capturing an image representing an actual temperature of the web downstream of the preheater station in the cross-machine direction with a thermal imaging device. The method also includes sending the image to a programmed process controller that applies thermal pattern recognition to the image and determining with the controller if the actual temperature of the web deviates from a desired temperature range. The method also includes determining with the controller a corrective action that will bring the actual temperature of the web within the desired temperature range and generating and sending a control signal with the controller to vary an operating condition of the preheater station so as to bring about the corrective action.

The present disclosure is also of a single facer for a corrugator. The single facer includes a timing corrugator roll defining a corrugating nip for corrugating flutes on a medium web and a liner preheater station feeding a liner web to the corrugating nip. A medium preheater station feeds the medium web to the corrugating nip. A first infusion preheater located at one of the liner preheater station and the medium preheater station comprises an arcuate outer surface having steam infusion apertures extending therethrough, wherein the steam infusion apertures are divided into laterally defined cross-machine direction groups, each group being separately connected to a steam supply from within the first infusion preheater. A thermal imaging device situated downstream of the first infusion preheater captures an image representing an actual temperature of a respective one of the liner web and the medium web in the cross-machine direction. A controller receives the image from the thermal imaging device and that applies thermal pattern recognition to the image to determine if the actual temperature of the respective one of the liner web and the medium web deviates from a desired temperature range. The controller sends a control signal to the first infusion preheater to vary a supply of steam to one or more groups of steam infusion apertures so as to bring the temperature of the respective one of the liner web and the medium web within the desired temperature range.

Various other features, objects and advantages of the disclosure will be made apparent from the following description taken together with the drawings.

### BRIEF DESCRIPTION OF THE DRAWINGS

The drawings illustrate several embodiments contemplated for carrying out the disclosure. In the drawings:

FIG. 1 is a schematic side elevation view of a single facer incorporating the preheaters and thermal imaging used in the method of the present disclosure.

FIG. 2 is a schematic side elevation of another embodiment of the disclosure in a single facer.

FIG. 3 is an enlarged vertical section through a preheater drum used in the practice of the present disclosure.

FIGS. 4A and 4B are vertical sections through a preheater drum used in the FIG. 1 embodiment of the present invention, respectively before and after drilling gun drilled bores.

FIGS. 5A and 5B are vertical sections through a preheater plate used in the FIG. 2 embodiment of the present invention, respectively before and after formation of the heating and infusion bores.

FIGS. 6A, 68 and 7A, 78 are top plan schematic views of FIGS. 4A and 4B, and 5A and 5B, respectively.

FIG. 8 is a schematic representation of a portion of a prior art web scanning system utilized to monitor moisture content and temperature of the running web

FIG. 9 shows a section of the running web in which the web is continuously scanned across its hill cross machine direction width, according to the present disclosure.

FIG. 10 is the digitized representation of the temperature or moisture content in the web as shown in FIG. 9.

FIGS. 11A-11D are serial schematics showing the movement of a liner web from an initial position to a zero wrap position.

FIG. 12 illustrates one example of a method according to the present disclosure.

### DETAILED DESCRIPTION OF THE PREFERRED EMBODIMENTS

The production of single face for corrugated board applications is dependent on three process variables that interact to produce quality single face at production speeds. The principal variables are heat, pressure and tension. Through the years, much work has been done in optimizing these variables for the fluted medium. Production of the fluted medium requires the application of heat to soften the lignin in the cellulose fibers to make the paper pliable. The proper application of moisture (usually in the form of a secondary/lower quality steam) softens the hydrostatic bonds that hold the cellulose fibers together so the paper can flow and move without damage during the fluting process. Tension in the medium is important because it grows exponentially during fluting, where the web is subject to travel in a serpentine path. This tension can exceed the strength of the paper and cause fracture. Pressure between the tips of the fluted medium and liner is needed to create the initial (green) bond that allows the single face to go onto the bridge where the starch that has been applied to the flute tips can properly gelatinize and form a final bond between the liner and medium.

Normally the medium is wrapped on an infusion plate or drum where the side to which starch adhesive will be applied to the flute tips is facing the surface of the plate. This will supply heat and steam to that surface.

Through the years there has been minimal work done in studying the process with respect to the liner that bonds to the medium to create the single face product. Heat is added to the paper with a floor mounted preheater. For liners (the opposing sheet of paper that bonds to the fluted medium), there can be occasions due to the temperature and moisture of the paper where one will wrap the infusion drum in one of two ways to either drive the moisture in the paper to the glue line or away from the glue line. That is, the side of the paper that will bond to the fluted medium can be wrapped. There can be times when it is better to wrap the opposite side of the paper (away from the flutes) to control warp. Tension is controlled by the splicer and roll stand that is feeding the liner to the preheater. Usually a single facer has art internal preheater that can do a final heating of the liner prior to its bonding to the medium flute tips (on which starch adhesive has been applied).

The present invention has motorized wrap rolls that can adjust the amount of paper wrap around the preheater infusion drum. Paper should be within a desired temperature range to flute properly, bond with the starch and provide a quality product. There are papers today (especially lighter paper) that can be overheated, get brittle, and fracture. Therefore, being able to adjust the heat input to a paper web has become increasingly important. Further, infusion zones across the width of the infusion drum or an infusion plate allow for control of heating and steam application in certain areas along the width of the paper. If the thermal imaging device detects zones where there are variations in temperature, an appropriate zone can be turned on or the steam pressure to that zone can be increased. A variable steam pressure is available to the operator. These adjustments can be made manually by the operator, or automatically by a process controller.

As operators look closer at the production constraints, it is evident that there can be unacceptable levels of variability in the single face liner. Uneven heat and moisture in the single face liner can contribute to unbonded areas (blister), wrinkling in the liner as it enters the single facer, and stresses in the combined single face that can cause unacceptable warp in the finished product. These process issues can be due to variations in moisture content in the liner across its width. This can be due to actual moisture variation or due to density variations in the paper across its width. Regardless of the situation, greater uniformity in both moisture and temperature in the liner, as it enters the single facer, will contribute to an optimized condition fur productivity.

A web conditioning process called infusion has been developed. A round drum or curved plate is steam heated and the outer surface of the drum or plate is provided with a plurality of holes or apertures through which steam can flow. The net effect is a device that can provide both heat and moisture to the liner or medium. The close proximity of the paper overlying the steam holes allows the steam to penetrate into the paper and diffuse among the paper fibers. As the steam condenses to water, it adds hot moisture to the paper to aid in the single face process, enhancing production. This development is described and shown in U.S. Pat. No. 6,050,316, which was incorporated by reference herein above. Upgrade applications of infusion have created both drums and plates where the steam holes can be piped into segments across its width. In this way steam can be applied to different areas of the plate or drum as needed. See U.S. Pat. No. 6,110,095, also incorporated by reference herein above.

The present disclosure provides automatic control, in real time, of the heat and/or moisture applied to a running single face web or the component liner and medium web to continuously watch for web variations in quality, strength, and uniformity. If any of these measured characteristics falls above or below respective upper and lower control limits, the programmed computer acts automatically to identify the sensed defect and take corrective action to adjust the steam and/or heat applied to the web(s).

Traditionally, corrugator operators and field engineers will look at the single face liner with a hand held infrared temperature gun. This technique will show an average temperature of the paper. Due to variations in paper emissivity, these guns can provide an approximate absolute temperature but more accurately a variation m temperature readings. These guns are not an effective process control tool for today's environment.

Modifications can be made to these hand held thermal imaging devices such as those provided by Flir Systems, Inc. of Wilsonville, Oreg. to instead monitor the temperature of the web across the entire width of the web at one moment in time. These modified devices will show a color picture of the paper (liner or medium). In the cross machine direction these modified devices can better show variations in web temperature that can have a negative effect on production and quality

As the corrugated paperboard industry adopted this technology, operational control evolved from control by a human operator monitoring web temperature and/or moisture content to programmed control. Unfortunately, progress was slow because the industry focused its attention more on the medium web. One result of this was the use of the above-mentioned thermal imaging device, typically hand-held, to spot check the running web and take remedial action when a defect is detected. However, because the small area. over which a thermal imaging device operates is relatively small (compared to a 96 inch wide web running at 1500 FPM), the result is the failure to detect many defects that are out of range of the thermal imaging device and thus go undetected. It would not be an exaggeration to suggest that the detection of a defect, which because of size and location in the web is not seen by the thermal imaging device, could result in 1,000 feet or more of defective single face web.

As an example, companies using prior art thermal imaging devices to monitor web temperature typically utilize a hand-held device that the user must point at the web to take a snapshot of the spot, or utilize a scanning device mounted over the running web and traversing back and forth in the cross machine direction. The scanning device may be two inches in diameter and would, for example, require thirty seconds to scan across the full width of the web. If the single facer is running at current speeds of about 1500 FPM, only a small area of the running web will be subject to scanning and large amounts of defective web could escape detection.

In accordance with the present invention, a thermal imaging device is mounted downstream of the preheater and is wide enough and positioned such that it can generate an image that covers the entire width of the web in the cross machine direction. The device is positioned to continuously scan the entire width of the web at one given moment in time without any gaps in the web surface to be scanned.

The present invention is directed in particular to thermal imaging of a full width of a running web, coupled with steam infusion and heat in an interactive process control to show a complete picture of the high speed running liner, medium, and single face web. Detection of the image in accordance with the present invention utilizes programmed process control to alter the heat applied to the running paperboard web, whether it be to correct a relatively small defect or a very large area.

The invention pertains to the application of both technologies (thermal imaging and infusion) into an inter-active process control. What is described herein is to mount an infusion drum or plate on either or both of the liner or medium side of the single facer. By placing a thermal imaging device directly after the infusion drum/plate an operator and/or controller, for example in a computer, can see the temperature variations in the paper. The infusion drum can be manually turned on by an operator to bring the paper to a higher level of temperature or moisture. Alternatively, algorithms can be programmed into the controller to do the same. If the thermal imaging device detects a cross machine variation that is concentrated in one area, an infusion zone in the infusion drum or plate can be turned on or off to level out the temperature image.

One embodiment of the invention includes a tension leveling roll prior to the infusion device. This style roll functions to even out the tension of the paper in the cross machine direction for a smoother, more even flow through the process. These variations can come from the paper mill as the paper is wound and can cause wrinkling and foldovers as the paper is being processed.

Another embodiment. is to add an idler roll with a tension brake. This can serve to adjust the tension of the paper as it wraps the infusion drum/plate. The tension roll can “pull out” variations due to the manner in which the paper roll was wound at the paper mill. it can also pull the paper into closer proximity to the infusion drum/plate to gain greater effectiveness.

Either of these devices (tension leveling roil or idler roll with a tension brake) can also be used to adjust the wrap and/or proximity of the web to the infusion drum or plate, thereby adding additional control over the temperature of the web.

Another embodiment is to provide an additional thermal imaging device mounted at the exit of the single facer that will allow the controller and/or operator to observe the final product exiting the machine to ensure an evenly heated and moistened product that goes to the bridge and prepares for the next step in corrugated board production.

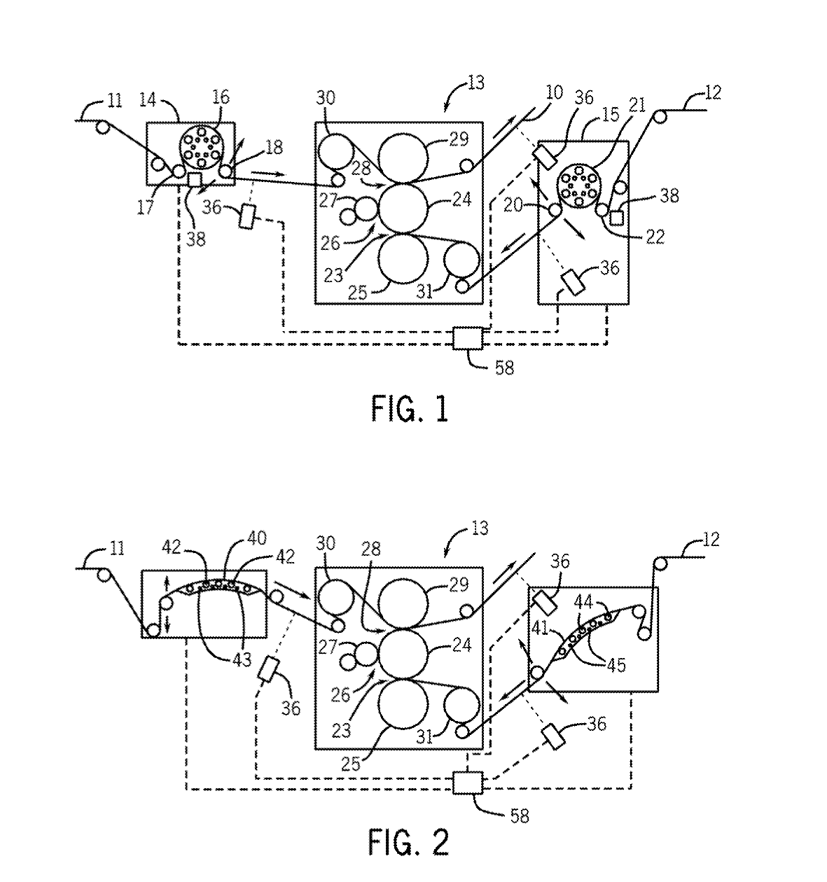

Referring first to FIG. 1, a single face corrugated paper web 10 is produced by combining a liner web 11 and a corrugated medium web 12 to form the single face web 10. The conversion of the liner web 11 and medium web 12 takes place in a single facer apparatus 13 where the webs 11 and 12 are joined by a starch-based adhesive to form the single face web 10, all in a manner well known in the art. A liner web preheater station 14 and a medium web preheater station 15 are also used to join the webs to form the single face web 10. In addition to the heat applied to the liner web 11 and medium web 12, various means are known in the art to maintain proper moisture content in the webs 11 and 12 as they are processed through the single facer 13.

As shown in FIG. 1, the liner web 11 moves into the liner web preheater station 14 where it is wrapped at least partially around the outer surface of a cylindrical liner preheater drum 16. The amount of liner web 11 that is wrapped on the liner preheater drum 16 is controlled by directing the liner web 11 around an idler wrap roll 17, around the outer surface of the preheater drum 16, and then around a circumferentially adjustable wrap roll 18, which can be moved in a circular arc as shown by the arrows to selectively increase or decrease the amount of wrap of the liner web 11 around the liner preheater drum 16 in order to control the amount of heat being applied to the web.

The pre-heated liner web 11 then moves directly into the single facer 13 where it is joined with the corrugated medium web 12.

At the same time, the medium web 12 (which has not yet been corrugated) is directed into the medium web preheater station 15 where it is processed in substantially the same manner as the liner web 11. Thus, the medium web 12 is initially wrapped around an idler roll 22, then wrapped around a medium preheater drum 21 from which it is taken off by the adjustable wrap roll 20 which is adjustable to vary the amount of wrap on the medium preheater drum 21 in a manner described above with respect to the liner web 11.

From the web preheater station 15, the medium web 12 moves directly into the single facer 13 where it is joined with the liner web 11 also in a manner generally known in the prior art. Thus, the medium web 12 from the medium preheater drum 21 travels into the single facer 13 and is directed to the fluting nip 23 of the upper and lower fluting rolls 24 and 25, respectively. From the fluting nip 23, the corrugated medium web 12 travels through a glue nip 26 between the upper fluting roll 24 and a glue roll 27 where the starch-based adhesive is applied to the outer flute tips of the medium web 12. The glued flute tips of the fluted medium web 12 join the liner web 11 in a bonding nip 28 formed between a bonding roll 29 and the upper fluting roll 24. The partially cured single face web 10 then passes out of the single facer 13 for further downstream processing.

It should be noted that heat may also be applied to either or both of the liner and the medium web in internal preheater 30 for the liner web 11 and internal preheater 31 for the medium web 12.

In the present disclosure. the primary source of heat and moisture applied to the respective webs is steam applied to the webs in the liner web preheater station 14 and the medium web preheater station 15. The primary liner web preheater station 14 and medium web preheater station 15 supply both heat and moisture to the webs and, in accordance with the present invention, do so in a manner that provides real time control of the temperature and moisture content of the rolls in the web preheaters 14 and 15. The present invention provides a method for minimizing cross machine direction variations in the temperature and moisture content of the liner web 11 and/or medium web 12 and for minimizing resultant wrinkling of the web, failure of the adhesive bond, and warp in the single face web 10.

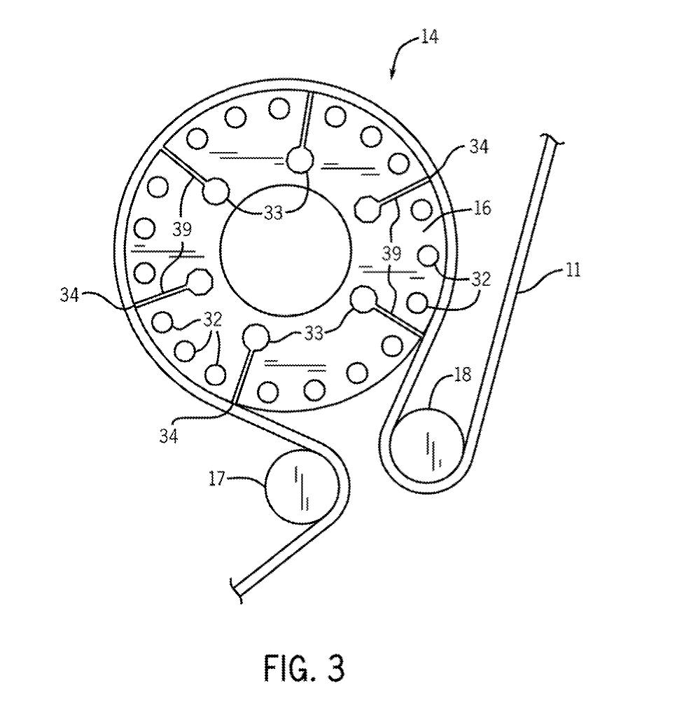

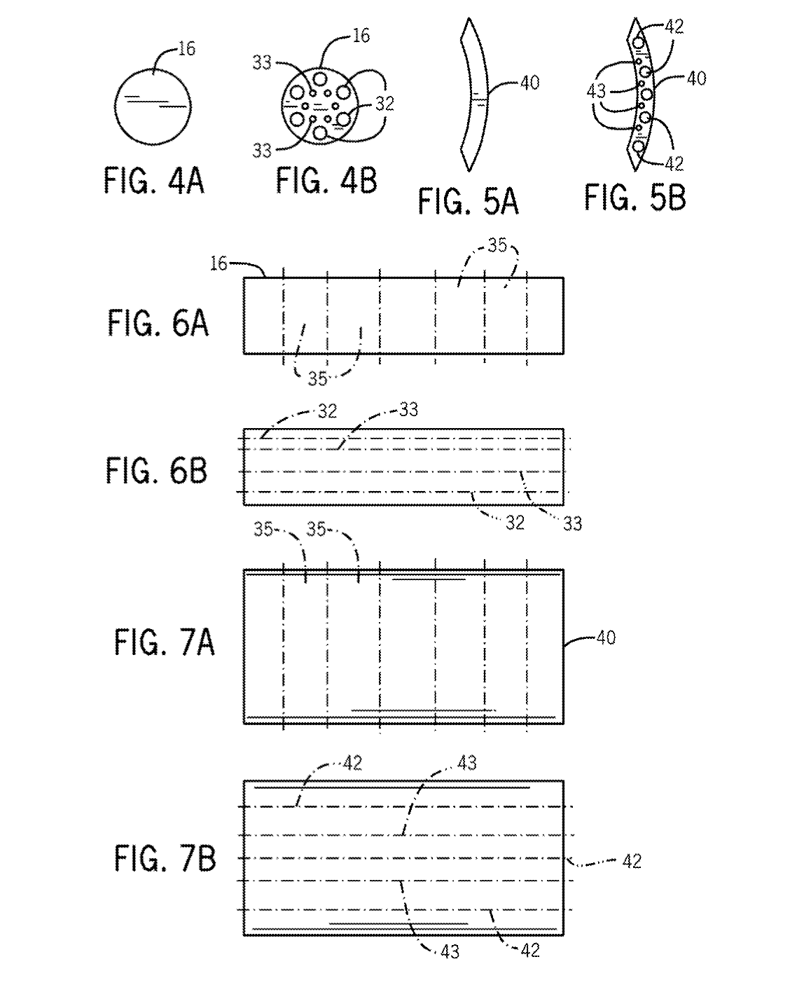

As best seen in FIG. 3, the liner web preheater station 14 utilizes a cylindrical liner preheater drum 16 that has axially extending internal heating bores 32 that provide overall heating of the liner preheater drum 16, and infusion bores 33 that direct super-heated steam to the outer surface of the liner preheater drum 16. Adjustment of the steam supplied to the infusion bores 33 thereby controls the steam infused into the liner web 11 and to the internal heating bores 32 as well. See also FIGS. 4B and 6B.

The infusion bores 33 include radially extending passages 39 through the wall of the liner preheater drum 16 defining infusion apertures 34 by which super-heated steam may be infused into the liner web 11, enhanced by the intimate contact of the liner web 11 running over the surface of the liner preheater drum 16. With reference to FIGS. 4A, 5A, 6A, and 7A, the steam infusion apertures 34 are arranged in lateral cross-machine direction zones or groups 35, each group 35 separately connected to the infusion bores 33. The zones or groups 35 of infusion apertures 34 through which the super-heated steam is directed may use supply manifolds within the liner preheater drum 16 where each group 35 of infusion apertures 34 is supplied with selectively operable valve arrangements. To adjust the temperature of the web 11, 12 that is wrapped around a certain group 35 of the preheater drums 16, 21, that group 35 can be turned on or off, or a higher or lower pressure of steam can be provided to that group 35. The incoming liner web 11 may be adjustably set to wrap the web around the surface of the liner preheater drum 16 to provide semi-circumferential contact with the drum, and thereby vary the heat applied to the liner web 11.

Although the drum of FIG. 3 has been referred to herein as the liner preheater drum 16, the description provided herein regarding process control over temperature by way of controlling the groups 35 of infusion apertures 34 is equally applicable to the medium preheater drum 21.

Now with reference back to FIG. 1, a thermal imaging device 36 is set to monitor the cross machine direction temperature of the liner web 11 and to provide an indication of a temperature deviation outside a desired range. The thermal image may indicate when cross machine direction temperature varies from a desired temperature to an undesirable temperature deviation caused by a defect in the liner, such as a wet spot, defective bond or warp in the web. Deviation outside the desired range may be controlled by manual or automatic control by adjusting zones or groups 35 (FIGS. 4A, 5A, 6A, 7A) to which steam is being sent and may also or alternatively be controlled by the extent of the wrap around the liner preheater drum 16.

Various arrangements of thermal imaging devices 36 may be utilized. In one arrangement, a thermal imaging device 36 is positioned downstream of each of the liner web preheater station 14, the medium web preheater station 15, and the single face web 10 downstream of the single facer 13. Alternately, the thermal imaging device 36 may be positioned downstream of one of the liner web preheater station 14, the medium web preheater station 15 Or the single face web 10 downstream of the single facer 13. It is believed that a minimally effective arrangement uses a thermal imaging device 36 downstream of the liner web preheater station 14. This is because the corrugated paper board industry has not paid as much attention to deficiencies or defects in the manner in which the liner web 11 is processed. Each of the thermal imaging devices 36 is in signal communication with a controller 58, which may apply thermal pattern recognition to the thermal images produced by each device 36 and may output control signals to vary conditions at the preheater stations 14, 15 in response so as to correct defects indicated by the thermal images. For example, the controller 58 may use the image of the actual temperature of the web across the entire width of the web in the cross machine direction to determine which of one or more groups 35 of infusion apertures 34 should be supplied with steam and at what pressure the steam should be supplied to bring the web back to the correct temperature.

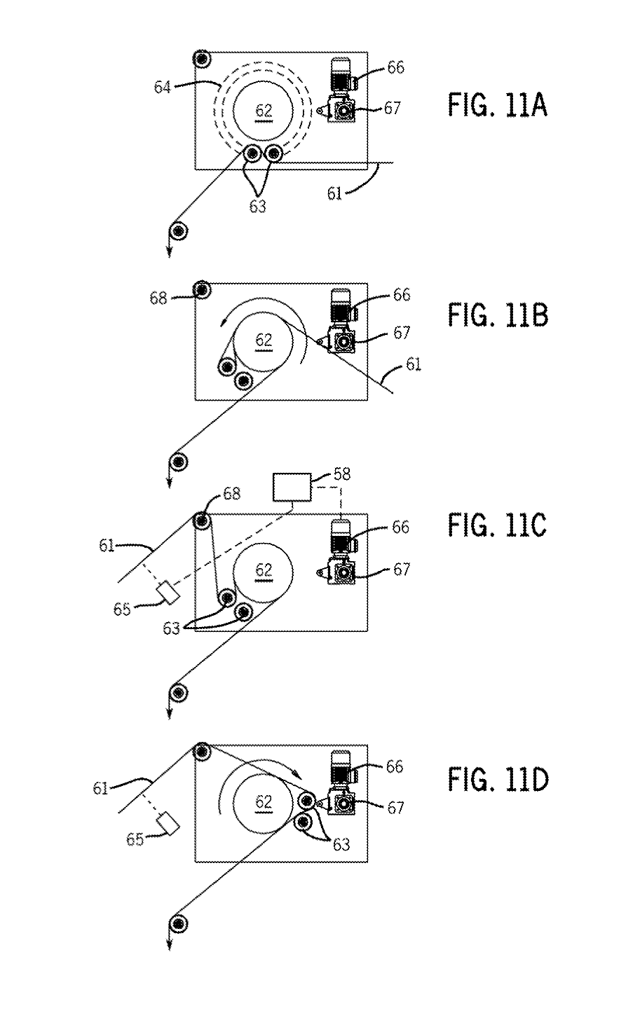

As discussed above, the method of the present invention may include the step of positioning an adjustable wrap roll 18 to even out the tension in the liner web 11 and to smooth the web as discussed above, as well as to control the wrap of the web around the drum, discussed further herein below with reference to FIG. 11. A further method step that may be utilized positions an idler roll tension brake 38 to further help adjust the tension in the liner web 11 to pull the web more evenly to the surface of the liner preheater drum 16. Each of these adjustments can be made in response to a signal from the controller 58, which is operatively connected to each of the liner preheater station 14 and the medium preheater station 15, and to actuators at these stations 14, 15 that actuate the preheater drums 16, 21, rolls 17, 18, 20, 22, and tension brakes 38.

In another embodiment of the method of the present invention, as shown schematically in FIG. 2, the liner preheater drum 16 and the medium preheater drum 21 are replaced by a liner preheater plate 40 and a medium preheater plate 41. The preheater plates 40 and 41 operate in substantially the same manner as preheater drums 16 and 21, respectively, as described above. Referring to FIGS. 5A and 5B the liner preheater plate 40 is provided with internal heating bores 42 and internal infusion bores 43. Similarly, the medium preheater plate 41 is provided with a plurality of internal heating bores 44 and a plurality of internal infusion bores 45, as shown. The construction and operation of the liner web preheater station 14 and medium web preheater station 15 of FIG. 1 is otherwise substantially the same as the operation of the liner preheater plate 40 and medium preheater plate 41. Further, a more detailed description of the preheater construction is shown in U.S. Pat. No. 6,050,316, incorporated by reference hereinabove. The infusion bores 43, 45 can be divided into zones or groups 35 as well, and control over these zones or groups 35 can be implemented by an operator or a controller, as described hereinabove with respect to FIGS. 4A-7A.

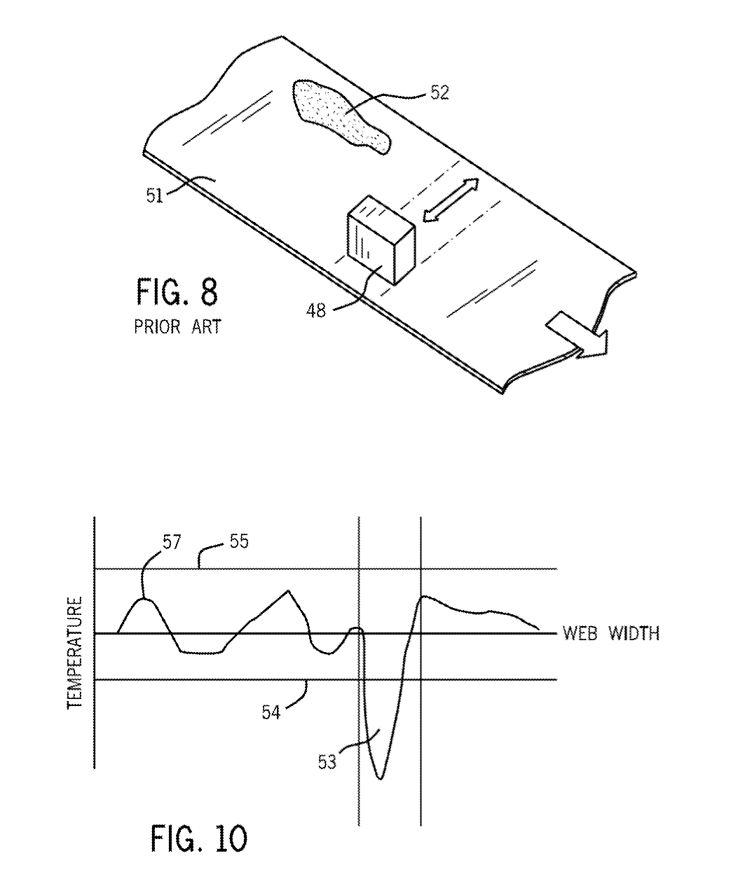

FIG. 8 is a schematic representation of a portion of a prior art web scanning system utilized to monitor moisture content in the web. The scanner 48 is positioned above the web 51 and is mounted on a suitable support permitting the scanner 48 to traverse the web 51 back and forth over the full width. If a defect such as a wet area 52 in the web 51 occurs, in theory the scanner 48 will detect the defect, and appropriate action can be taken either by an observing operator or by a control system that receives a signal regarding the defect. In FIG. 8, however, the defective area (wet or dry) is offset in the cross machine direction from the scanner 48 such that the defect may not be seen due to the speed of the web 51 and will continue through the run without detection. As indicated above, failure to read a defect can result in loss of 1,000 or more feet of otherwise good web 51.

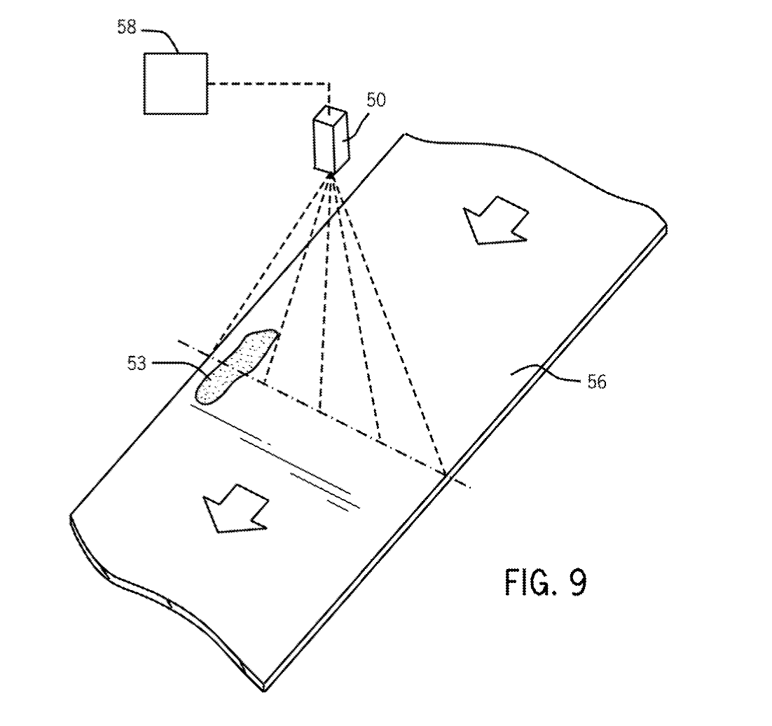

The present disclosure is shown schematically in FIG. 9 where the traveling web 56 (liner web, medium web, or single face web) is constantly monitored in the full cross machine direction such that the entire web 56 may be scanned for defects of the type described above, thereby overcoming serious deficiencies in the prior art and realizing corresponding cost savings. Using a special full width thermal imaging device 50, the monitoring system is continuously and fully operable across the web to identify defects and send them to the controller 58 for processing and corrective action.

Instead of the thermal imaging device 50 showing a fan-like detector beam, the present invention may utilize a full web width scanning support (not shown) in which the scanning beams are parallel and of more uniform lengths, thereby enhancing uniformity in the scans.

FIG. 10 shows one example scan resulting from operation of a full width image of the running web 56 using the thermal imaging device 50. The graph shows upper control limit 55 and lower control limit 54. The line 57 represents the temperature of the web across the entire width of the web at one moment in time as detected by the thermal imaging device 50. The example scan shows an area of a defect 53 outside the lower control limit 54, representing excessive moisture or temperature. A temperature above the upper control limit 55 would indicate that the web is too hot and/or dry.

Referring particularly to FIG. 1, the system of the present disclosure utilizes a programmable controller 58 that receives images from the thermal imaging device 50 and applies thermal pattern recognition to the image to determine if the web temperature (represented by line 57) deviates from a desired temperature range (i.e., outside of upper and lower limits 55, 54). Controller 58 can be in wired or wireless signal communication with the thermal imaging devices 36 and preheater stations 14, 15 of the single facer 13. The controller 58 may include a programmable processor and programmable input/output peripherals. As is conventional, the processor can be communicatively connected to a computer readable medium that includes volatile or non-volatile memory upon which computer readable code is stored. The processor can access the computer readable code on the computer readable medium and upon executing the code, carries out various functions of the single facer 13 as described herein. In one example, the controller 58 sends an appropriate control signal to an infusion preheater to vary a supply of steam to one or more groups 35 of steam infusion apertures 34 so as to bring the temperature of liner web or medium web within the desired temperature range. in another example, the computer readable code may include instructions as to what process control variable should be changed (amount or pressure of steam, degree of wrap, etc.), and for how long a period of time, based on the magnitude of deviation from the desired temperature range and/or the size of the defect 53.

FIG. 11 schematically shows a series of views of the wrap positions of a web 61 around and in association with an infusion preheater drum 62. In a thread up position in FIG. 11A, the preheater drum 62 is not contacted by a pair of idler rolls 63, which are mounted to a rotating carrier 64 that rotates around the preheater drum 62. The idler rolls 63 travel together on the rotating carrier 64 around the preheater drum 62. A motor 66 and gearbox 67 can be used to rotate the carrier 64 and thus the idler rolls 63 to any position between substantially full wrap of the web 61 around the preheater drum 62 to minimal wrap, with no more than tangent contact of the web 61 with the preheater drum 62.

FIG. 11B shows the idler rolls 63 in a position in which they have been rotated around the preheater drum 62 by about 320 degrees counterclockwise in the direction of the arrow shown therein, in order to provide initial wrap of the web 61. The free end of the web 61 is then brought over idler roll 68, and fed to the single facer 13. FIG. 11C shows the full wrap position of the idler rolls 63. FIG. 11C also shows the connection of the thermal imaging device 65 to the controller 58 of FIG. 1, which is in turn in signal communication with the motor 66. In response to a reading from the thermal imaging device 65, the controller 58 can send a signal to control the position of the tension leveling idler rolls 63 with respect to the preheater drum 62 so as to adjust a degree to which the web is wrapped around the preheater drum 62. For example, if the web is extremely wet, it may be desirable to increase the wrap around the drum 62, so that the web 61 stays in contact with the heated surface for a longer period of time. FIG. 11D shows the minimal wrap position, in which the idler rolls 63 have been rotated hack around the preheater drum 62 in a clockwise direction, as shown by the arrow therein. A thermal imaging device 65 is mounted in a fixed position downstream of the preheater drum 62. The thermal imaging device 65 can be positioned as desired to monitor the temperature of the web 61.

Many other arrangements of the web-carrying idler rolls 63 are possible and provide flexibility to the system that is adaptable to many different single facer and preheater drum positions to accommodate varying physical locations of the equipment.

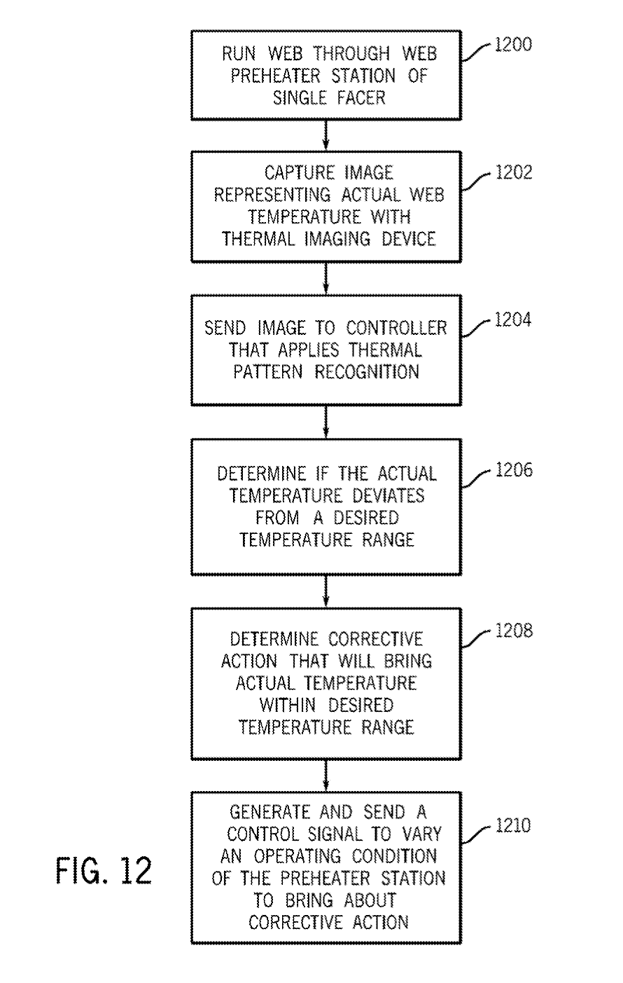

Now referring to FIG. 12, a method for minimizing cross-machine direction variations in temperature and moisture content of a web 10, 11, 12 running through a corrugator single facer 13 will be described. As shown at 1200, the method includes running the web through a web preheater station 14, 15 of the single facer 13. As shown at 1202, the method includes capturing an imago representing an actual temperature of the web downstream of the preheater station in the cross-machine direction with a thermal imaging device 36. The method also includes sending the image to a programmed process controller 58 that applies thermal pattern recognition to the image, as shown at 1204. As shown at 1206, the method next includes determining with the controller 58 if the actual temperature of the web deviates from a desired temperature range, and at 1208. determining with the controller 58 a corrective action that will bring the actual temperature of the web within the desired temperature range. The method then includes generating and sending a control signal with the controller 58 to vary an operating condition of the preheater station 14, 15 so as to bring about the corrective action, as shown at 1210.

In other examples, the method may include sending a control signal to adjust release of steam provided through a plurality of apertures 34 in an arcuate outer surface of an infusion preheater 16, 21, 40, 41 located at the preheater station; sending a control signal to vary a pressure of the steam provided through the plurality of apertures: and/or sending a control signal to provide the steam through one or more subsets of apertures in the plurality of apertures. The subsets of apertures may be divided into laterally defined cross-machine direction groups 35 of apertures 34, each group 35 of apertures being separately connected to a steam supply from within the infusion preheater. The method may further comprise sending a control signal to one of increase and decrease a supply of steam to a group 35 of apertures that corresponds to a portion of the web that the controller 58 has determined has a temperature that deviates from the desired temperature range.

In yet further examples, the method includes controlling a position of the web with respect to the infusion preheater, such as by adjusting a degree in which the web is wrapped around the infusion preheater by controlling a position of a tension leveling idler roll located at the preheater station (FIG. 11) or by adjusting a tension of the web and a proximity of the web to the infusion preheater by controlling actuation of a tension brake on an idler roll located at the preheater station (FIG. 1).

The method may also include determining a difference between the actual temperature of the web at a particular cross-machine position and one of an upper 55 and a lower 54 threshold of the desired temperature range, and selecting which operating condition of the preheater station should be varied to most efficiently bring the actual temperature back within the desired temperature range.

This written description uses examples to illustrate the present disclosure, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. A method for minimizing cross-machine direction variations in temperature and moisture content of a web running through a corrugator single facer, the method comprising:
running the web through a web preheater station of the single facer;
capturing an image representing an actual temperature of the web downstream of the preheater station in the cross-machine direction with a thermal imaging device;
sending the image to a programmed process controller that applies thermal pattern recognition to the image;
determining with the controller if the actual temperature of the web deviates from a desired temperature range;
determining with the controller a corrective action that will bring the actual temperature of the web within the desired temperature range; and
generating and sending a control signal with the controller to vary an operating condition of the preheater station so as to bring about the corrective action.

2. The method of claim 1, further comprising sending a control signal to adjust release of steam provided through a plurality of apertures in an arcuate outer surface of an infusion preheater located at the preheater station.

3. The method of claim 2, further comprising sending a control signal to vary a pressure of the steam provided through the plurality of apertures.

4. The method of claim 2, further comprising sending a control signal to provide the steam through one or more subsets of apertures in the plurality of apertures.

5. The method of claim 4, wherein the subsets of apertures are divided into laterally defined cross-machine direction groups of apertures, each group of apertures being separately connected to a steam supply from within the infusion preheater.

6. The method of claim 5, further comprising sending a control signal to one of increase and decrease a supply of steam to a group of apertures that corresponds to a portion of the web that the controller has determined has a temperature that deviates from the desired temperature range.

7. The method of claim 2, further comprising controlling a position of the web with respect to the infusion preheater.

8. The method of claim 7 further comprising adjusting a degree to which the web is wrapped around the infusion preheater by controlling a position of a tension leveling idler roll located at the preheater station.

9. The method of claim 7, further comprising adjusting a tension of the web and a proximity of the web to the infusion preheater by controlling actuation of a tension brake on an idler roll located at the preheater station.

10. The method of claim 1, further comprising determining a difference between the actual temperature of the web at a particular cross-machine position and one of an upper and a lower threshold of the desired temperature range, and selecting which operating condition of the preheater station should be varied to most efficiently bring the actual temperature back within the desired temperature range.

11. The method of claim 10, further comprising choosing to vary one or more of the following operating conditions of the preheater station:
a pressure of steam provided through a plurality of apertures in an arcuate outer surface of an infusion preheater located at the preheater station;
provision of steam through one or more subsets of apertures in the plurality of apertures;
a degree to which the web is wrapped around the infusion preheater; and
a tension of the web and a proximity of the web to the infusion preheater.

12. The method of claim 1, further comprising positioning a thermal imaging device downstream of a liner web preheater station, downstream of a medium web preheater station, and downstream of a corrugating nip of the single facer.

13. The method of claim 1, wherein the image represents an actual temperature of the web across the entire width of the web in the cross-machine direction at a given moment in time.

14. A single facer for a corrugator, the single facer comprising:
a forming corrugator roll defining a corrugating nip for corrugating flutes on a medium web;
a liner preheater station feeding a liner web to the corrugating nip;
a medium preheater station feeding the medium web to the corrugating nip;
a first infusion preheater located at one of the liner preheater station and the medium preheater station, the first infusion preheater comprising an arcuate outer surface having steam infusion apertures extending therethrough, wherein the steam infusion apertures are divided into laterally defined cross-machine direction groups, each group being separately connected to a steam supply from within the first infusion preheater;
a thermal imaging device situated downstream of the first infusion preheater that captures an image representing an actual temperature of a respective one of the liner web and the medium web in the cross-machine direction; and
a controller that receives the image from the thermal imaging device and that applies thermal pattern recognition to the image to determine if the actual temperature of the respective one of the liner web and the medium web deviates from a desired temperature range;
wherein the controller sends a control signal to the first infusion preheater to vary a supply of steam to one or more groups of steam infusion apertures so as to bring the temperature of the respective one of the liner web and the medium web within the desired temperature range.

15. The single facer of claim 14, further comprising a second infusion preheater located at the other of the liner preheater station and the medium preheater station, wherein the controller also sends a control signal to the second infusion preheater to vary a supply of steam to one or more groups of steam infusion apertures in an arcuate outer surface of the second infusion preheater so as to bring the temperature of the other of the liner web and the medium web within the desired temperature range.

16. The single facer of claim 15, further comprising an additional thermal imaging device downstream of the second infusion preheater that sends an additional image representing an actual temperature of the other of the liner web and the medium web in the cross-machine direction to the controller.

17. The single facer of claim 14, further comprising a tension leveling idler roll associated with the first infusion preheater, wherein the controller also sends a control signal to control the position of the tension leveling idler roll with respect to the first infusion preheater so as to adjust a degree to which the one of the liner web and the medium web is wrapped around the first infusion preheater.

18. The single facer of claim 14, further comprising a tension brake on an idler roll associated with the first infusion preheater, wherein the controller also sends a control signal to actuate the tension brake so as to adjust a tension of the one-of the liner web and the medium web and a proximity of the one of the liner web and the medium web to the first infusion preheater.

19. The single facer of claim 14, wherein the thermal imaging device is positioned such that the image it captures represents an actual temperature of the one of the liner web and the medium web across the entire width of the web m the cross-machine direction at a given moment in time.

20. The single facer of claim 19, wherein the controller uses the image of the actual temperature of the one of the liner web and the medium web across the entire width of the web in the cross-machine direction to determine which of the one or more groups of steam infusion apertures should be supplied with steam and at what pressure the steam should be supplied.
